(19) United States
(12) Patent Application Publication
(10) Pub. No.: US 2010/0312722 A1
(43) Pub. Date: Dec. 9, 2010

(54) Privately Provisioned Sub-Unit-Based Survival Supplies Provisioning Method

(76) Inventor: Barrett H. Moore, Winnetka, IL (US)

Correspondence Address: FITCH EVEN TABIN & FLANNERY, 120 SOUTH LASALLE STREET, SUITE 1600, CHICAGO, IL, 60603-3406, US

(21) Appl. No.: 11/532,461

(22) Filed: Sep. 15, 2006

Related U.S. Application Data
(63) Continuation-in-part of application No. 11/384,037, filed on Mar. 17, 2006, now abandoned.
Application No. 11/384,037 is a continuation-in-part of application No. 11/394,350, filed on Mar. 30, 2006, now abandoned.
Application No. 11/394,350 is a continuation-in-part of application No. 11/279,333, filed on Apr. 11, 2006.
Application No. 11/279,333 is a continuation-in-part of application No. 11/379,929, filed on Apr. 24, 2006, now abandoned.
Application No. 11/379,929 is a continuation-in-part of application No. 11/381,247, filed on May 2, 2006, now abandoned.
Application No. 11/381,247 is a continuation-in-part of application No. 11/381,257, filed on May 2, 2006, now abandoned.
Application No. 11/381,257 is a continuation-in-part of application No. 11/381,265, filed on May 2, 2006, now abandoned.
Application No. 11/381,265 is a continuation-in-part of application No. 11/381,277, filed on May 2, 2006.
Application No. 11/381,277 is a continuation-in-part of application No. 11/383,022, filed on May 12, 2006, now abandoned.
Application No. 11/383,022 is a continuation-in-part of application No. 11/420,594, filed on May 26, 2006, now abandoned.
Application No. 11/420,594 is a continuation-in-part of application No. 11/421,694, filed on Jun. 1, 2006, now abandoned.
Application No. 11/421,694 is a continuation-in-part of application No. 11/423,594, filed on Jun. 12, 2006, now abandoned.
Application No. 11/423,594 is a continuation-in-part of application No. 11/425,043, filed on Jun. 19, 2006, now abandoned.
Application No. 11/425,043 is a continuation-in-part of application No. 11/426,231, filed on Jun. 23, 2006.
Application No. 11/426,231 is a continuation-in-part of application No. 11/456,472, filed on Jul. 10, 2006, now abandoned.
Application No. 11/456,472 is a continuation-in-part of application No. 11/461,605, filed on Aug. 1, 2006, now abandoned.
Application No. 11/461,605 is a continuation-in-part of application No. 11/461,624, filed on Aug. 1, 2006.
Application No. 11/461,624 is a continuation-in-part of application No. 11/462,795, filed on Aug. 7, 2006.
Application No. 11/462,795 is a continuation-in-part of application No. 11/462,845, filed on Aug. 7, 2006, now abandoned.
Application No. 11/462,845 is a continuation-in-part of application No. 11/464,751, filed on Aug. 15, 2006, now abandoned.
Application No. 11/464,751 is a continuation-in-part of application No. 11/464,764, filed on Aug. 15, 2006, now abandoned.
Application No. 11/464,764 is a continuation-in-part of application No. 11/464,775, filed on Aug. 15, 2006.
Application No. 11/464,775 is a continuation-in-part of application No. 11/464,788, filed on Aug. 15, 2006, now abandoned.
Application No. 11/464,788 is a continuation-in-part of application No. 11/464,799, filed on Aug. 15, 2006, now abandoned.
Application No. 11/464,799 is a continuation-in-part of application No. 11/465,063, filed on Aug. 16, 2006.
Application No. 11/465,063 is a continuation-in-part of application No. 11/466,727, filed on Aug. 23, 2006, now abandoned.
Application No. 11/466,727 is a continuation-in-part of application No. 11/466,953, filed on Aug. 24, 2006, now abandoned.
Application No. 11/466,953 is a continuation-in-part of application No. 11/470,156, filed on Sep. 5, 2006, now abandoned.
Application No. 11/470,156 is a continuation-in-part of application No. 11/531,651, filed on Sep. 13, 2006, now abandoned.

(51) Int. Cl. G06Q 90/00

(52) U.S. Cl. 705/500

(57) ABSTRACT

A private civil security subscription mechanism serves to facilitate the provision of survival supplies for corresponding authorized beneficiaries. These supplies are segregated into sub-units dedicated to like supplies such that one sub-unit includes supplies of a particular category of supply. The sub-units may be differentiated such that within each category of supply are available different kinds of supplies. The sub-units of supplies can be fully or partially formed into a unit of supplies or can remain separate sub-units. If desired, an additional amount of supplies can be added to the unit if requested by the authorized beneficiary.

### RELATED APPLICATIONS

This application comprises a continuation-in-part of:

SUBSCRIPTION-BASED PRIVATE CIVIL SECURITY FACILITATION METHOD as filed on Mar. 17, 2006 and having application Ser. No. 11/384,037;

SUBSCRIPTION-BASED CATASTROPHE-TRIGGERED MEDICAL SERVICES FACILITATION METHOD as filed on Mar. 30, 2006 and having application Ser. No. 11/394,350;

PERSONAL PROFILE-BASED PRIVATE CIVIL SECURITY SUBSCRIPTION METHOD as filed on Apr. 11, 2006 and having application Ser. No. 11/279,333;

RADIATION SHELTER KIT APPARATUS AND METHOD as filed on Apr. 24, 2006 and having application Ser. No. 11/379,929;

FRACTIONALLY-POSSESSED UNDERGROUND SHELTER METHOD AND APPARATUS as filed on May 2, 2006 and having application Ser. No. 11/381,247;

SUBSCRIPTION-BASED CATASTROPHE-TRIGGERED TRANSPORT SERVICES FACILITATION METHOD AND APPARATUS as filed on May 2, 2006 and having application Ser. No. 11/381,257;

SUBSCRIPTION-BASED MULTI-PERSON EMERGENCY SHELTER METHOD as filed on May 2, 2006 and having application Ser. No. 11/381,265;

SUBSCRIPTION-BASED CATASTROPHE-TRIGGERED RESCUE SERVICES FACILITATION METHOD AND APPARATUS as filed on May 2, 2006 and having application Ser. No. 11/381,277;

DOCUMENT-BASED CIVILLY-CATASTROPHIC EVENT PERSONAL ACTION GUIDE FACILITATION METHOD as filed on May 12, 2006 and having application Ser. No. 11/383,022;

RESCUE CONTAINER METHOD AND APPARATUS as filed on May 26, 2006 and having application Ser. No. 11/420,594;

PURCHASE OPTION-BASED EMERGENCY SUPPLIES PROVISIONING METHOD as filed on Jun. 1, 2006 and having application Ser. No. 11/421,694;

SUBSCRIPTION-BASED PRE-PROVISIONED TOWABLE UNIT FACILITATION METHOD as filed on Jun. 12, 2006 and having application Ser. No. 11/423,594;

RADIATION-BLOCKING BLADDER APPARATUS AND METHOD as filed on Jun. 19, 2006 and having application Ser. No. 11/425,043;

PRIVATE CIVIL DEFENSE-THEMED TELEVISION BROADCASTING METHOD as filed on Jun. 23, 2006 and having application Ser. No. 11/426,231;

EMERGENCY SUPPLIES PRE-POSITIONING AND ACCESS CONTROL METHOD as filed on Jul. 10, 2006 and having application Ser. No. 11/456,472;

PRIVATE CIVIL DEFENSE-THEMED BROADCASTING METHOD as filed on Aug. 1, 2006 and having application Ser. No. 11/461,605;

METHOD OF PROVIDING VARIABLE SUBSCRIPTION-BASED ACCESS TO AN EMERGENCY SHELTER as filed on Aug. 1, 2006 and having application Ser. No. 11/461,624;

SUBSCRIPTION-BASED INTERMEDIATE SHORT-TERM EMERGENCY SHELTER METHOD as filed on Aug. 7, 2006 and having application Ser. No. 11/462,795;

SUBSCRIPTION-BASED CATASTROPHE-TRIGGERED RESCUE SERVICES FACILITATION METHOD USING WIRELESS LOCATION INFORMATION as filed on Aug. 7, 2006 and having application Ser. No. 11/462,845;

PRIVATELY PROVISIONED SURVIVAL SUPPLIES DELIVERY METHOD as filed on Aug. 15, 2006 and having application Ser. No. 11/464;751;

PRIVATELY PROVISIONED SURVIVAL SUPPLIES SUB-UNIT-BASED DELIVERY METHOD as filed on Aug. 15, 2006 and having application Ser. No. 11/464,764;

PRIVATELY PROVISIONED SURVIVAL SUPPLIES ACQUISITION METHOD as filed on Aug. 15, 2006 and having application Ser. No. 11/464,775;

PRIVATELY PROVISIONED SURVIVAL SUPPLIES CONTENT ACQUISITION METHOD as filed on Aug. 15, 2006 and having application Ser. No. 11/464,788;

METHOD TO PRIVATELY PROVISION SURVIVAL SUPPLIES THAT INCLUDE THIRD PARTY ITEMS as filed on Aug. 15, 2006 and having application Ser. No. 11/464,799;

WASTE DISPOSAL DEVICE as filed on Aug. 16, 2006 and having application Ser. No. 11/465,063;

SUBSCRIPTION-BASED PRIVATE CIVIL SECURITY RESOURCE CUSTOMIZATION METHOD as filed on Aug. 23, 2006 and having application Ser. No. 11/466,727;

PREMIUM-BASED PRIVATE CIVIL SECURITY POLICY METHODS as filed on Aug. 24, 2006 and having application Ser. No. 11/466,953;

SUBSCRIPTION-BASED MOBILE SHELTER METHOD as filed on Sep. 5, 2006 and having application Ser. No. 11/470,156; and

METHOD OF PROVIDING A FLOATING LIFE-SUSTAINING FACILITY as filed on Sep. 13, 2006 and having application Ser. No. 11/531,651;

the contents of each of which are fully incorporated herein by this reference.

### TECHNICAL FIELD

This invention relates generally to the provision of survival supplies.

### BACKGROUND

Many citizens of the world have long passed the point when a ready availability of the basic necessities of life is satisfactory in and of itself. Today's consumer-oriented citizens demand, and often receive, an incredibly diverse and seemingly ever-growing cornucopia of consuming and experiential options. Such riches are typically based, in turn, upon a highly interdependent series of foundational infrastructure elements. Examples of the latter include, but are certainly not limited to:

transportation infrastructure such as roads, bridges, railways, and so forth that facilitate the inexpensive and rapid movement of sometimes perishable goods from source to consumer;

communications infrastructure such as telephones, television, radio, and the Internet that facilitate the inexpensive and rapid sharing of news, advice, information, and entertainment; and

the totality of civil services such as police services, fire fighting services, medical services, and so forth that facilitate a sufficient degree of order and predictability to, in turn, permit the complex series of inter-related actions that modern society requires in order to operate.

As powerful as the machinery of modern life appears, however, modern citizens are today perhaps more at risk of experiencing a serious disruption in their ability to prosper or even to survive en mass than is generally perceived. Providing the necessities of life in general requires a lot of things to all operate, more or less, correctly. To put it another way, a serious disruption to any significant element of civilized infrastructure can produce catastrophic results for a broad swath of a given civil community. Any number of natural and/or non-naturally-caused events can greatly disrupt society's infrastructure and ability to provide one or more life-sustaining resources such as water, nutrition, shelter, and the like.

This situation exists in large measure due to the just-in-time nature of modern inventory and control schemes and practices. As but one example, studies have shown that a typical modern urban grocery store has but a few days worth of inventory on hand at any given time. Without a virtually constant re-supply stream, shelves would quickly go bare. A significant disruption to supply chains, then, can lead to a rapid depletion of available stock. This, in turn, can lead to critical shortages of necessary emergency supplies at the very moment when such supplies are most needed. The unpredictability with respect to what supplies may become limited in this regard can comprise a particularly troubling component of this problem.

Many people believe and trust that their government (local, regional, and/or national) will provide for them in the event of such a civilly-catastrophic event. And, indeed, in the long view such is clearly a legitimate responsibility owed by any government to its citizens. That such is a consummation devoutly to be wished, however, does not necessarily make it so. Hurricane Katrina provided some insight into just how unprepared a series of tiered modern governmental entities may actually be to respond to even basic survival needs when a catastrophic event occurs.

Such insights, of course, are not particularly new. Civil preparedness shortcomings occasionally attract public attention and niche marketing opportunities exist with respect to provisioning the needs of so-called survivalists. Indeed, there are those who spend a considerable amount of their time and monetary resources attempting to ready themselves to personally survive a civilly-catastrophic event. Therein, however, lies something of a conundrum.

On the one hand, modern governments typically do little to proactively ensure the bulk provisioning (let alone the comfort) of their citizens in the face of many or most catastrophic events. On the other hand, attempting to take responsible actions to reasonably ensure one's own safety and security can become, in and of itself, nearly a full-time avocation and leave little time to actually enjoy the conveniences and opportunities of modern life. Such individual actions may even be frowned upon by the greater part of society which has grown accustomed to and falsely secure with existing efficient just-in-time delivery systems that provide the illusion of plenty while undercutting the perception of risk.

As a result, many (if not most) individuals and their families are largely bereft of the supplies that they will need should a civilly-catastrophic event befall them. This shortcoming tends to be relatively comprehensive; most people have neither a sufficient selection of survival supplies nor a sufficient quantity. For people who do have a store of supplies set aside against such an eventuality, it can be a considerable burden to maintain and ensure the freshness, vitality, and usability of those supplies. At the same time, the same civilly-catastrophic event that occasions their need for supplies will also likely disrupt relevant supply chains enough to cause a partial or complete shortage of supplies at their local merchants. The unfortunate net result is a relatively near term severe need for a variety of survival supplies that will often go unmet for lengthy periods of time.

### BRIEF DESCRIPTION OF THE DRAWINGS

The above needs are at least partially met through provision of the sub-units-based survival supplies provisioning method described in the following detailed description, particularly when studied in conjunction with the drawings, wherein:

FIG. 1 comprises a flow diagram as configured in accordance with various embodiments of the invention; and

FIG. 2 comprises a schematic block diagram as configured in accordance with various embodiments of the invention

Skilled artisans will appreciate that elements in the figures are illustrated for simplicity and clarity. For example, common but well-understood elements that are useful or necessary in a commercially feasible embodiment are often not described in order to facilitate a less obstructed understanding of these various embodiments of the present invention. It will further be appreciated that certain actions and/or steps may be described or depicted in a particular order of occurrence while those skilled in the art will understand that such specificity with respect to sequence is not actually required. It will also be understood that the terms and expressions used herein have the ordinary meaning as is accorded to such terms and expressions with respect to their corresponding respective areas of inquiry and study except where specific meanings have otherwise been set forth herein.

### DETAILED DESCRIPTION

Generally speaking, pursuant to these various embodiments, a subscription-based approach serves to facilitate the procurement of survival supplies for corresponding authorized beneficiaries and to further facilitate the organization, management, and selection of such supplies. In addition, various approaches are set with respect to the selection of the form and manner of providing, storing, and delivering the supplies.

So configured, authorized beneficiaries of such consideration-based private civil security subscriptions will have concrete, predictable access to survival supplies upon the occurrence (and/or threat) of a civilly-catastrophic event. The selection and quantity of emergency survival items can be generally selected (and their maintenance governed) by experts and hence relieve the authorized beneficiary of responsibility in this regard.

These steps are readily facilitated without dependency upon governmental oversight, participation, or control. The particular supplies (and/or quantity of supplies) provided can vary with the needs and requirements of the authorized beneficiaries. Importantly, via these teachings, an individual can take important steps to bring a considerably improved measure of security into their lives, knowing that, should a civilly-catastrophic event indeed be visited upon them, they will have an extraordinary and reliable access to survival supplies.

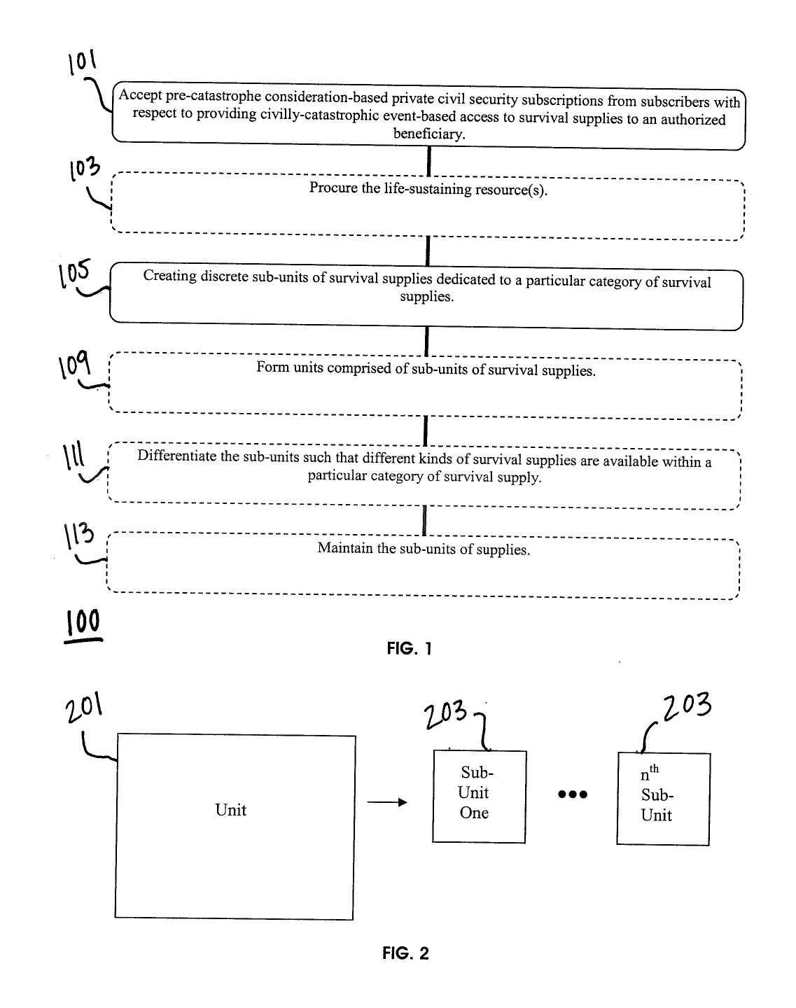

These and other benefits may become clearer upon making a thorough review and study of the following detailed description. Referring now to the drawings, and in particular to FIG. 1, an illustrative process 100 provides for accepting 101 consideration-based private civil security subscriptions from corresponding subscribers with respect to providing civilly-catastrophic event-based access to survival supplies. This right of access can pertain, if desired, to a predetermined period of time. For example, a given subscription can relate to providing access to the survival supplies for a one-year period of time for one or more authorized beneficiaries as correspond to that subscription.

By one approach, these subscriptions may be accepted by, for example, a for-profit business. By another approach a not-for-profit business (such as a membership-based-entity) may be the appropriate entity to offer and accept such subscriptions.

As noted, these teachings provide for a subscription-based approach. As used herein, the term “subscription” shall be understood to refer to and encompass a variety of legal mechanisms. Some relevant examples include, but these teachings are not limited to, subscription mechanisms such as:

time-limited rights of access (as where a subscription provides access rights for a specific period of time, such as one year, in exchange for a corresponding series of payments);

event-limited rights of access (as where a subscription provides access rights during the life of a given subscriber based upon an up-front payment in full and where those access rights terminate upon the death of the subscriber or where, for example, a company purchases a subscription for a key employee and those corresponding rights of access terminate when and if that key employee leaves the employment of that company);

inheritable rights of access (as may occur when the subscription, by its own terms and conditions, provides a right of access that extend past the death of a named subscription beneficiary and further provides for testate and/or intestate transfer to an heir);

rights of access predicated upon a series of periodic payments (as where a subscription provides access rights during, for example, predetermined periods of time on a periodic basis as where a subscriber offers month-by-month payments to gain corresponding month-by-month access rights);

rights of access predicated upon a one-time payment (as may occur when a subscriber makes a single payment to obtain a time-based or event-based duration of access rights or, if desired, when a single payment serves to acquire a one-time-only right of access or a perpetual right of access that may be retained, transferred, inherited, or the like);

ownership-based rights of access (as may occur when the subscription provides for ownership rights with respect to the survival supplies);

non-transferable rights of access (as may occur when the subscription, by its terms and conditions, prohibits transfer of the right of access to the survival supplies from a first named beneficiary to another);

transferable rights of access (as may occur when the subscription, by its terms and conditions, permits conditional or unconditional transfer of the right of access from a first named beneficiary to another);

membership-based rights of access (as may occur when the subscription, by its terms and conditions, establishes a membership interest with respect to the accorded right of access such as, for example, a club-based membership);

fractionally-based rights of access (as may occur when the subscription, by its terms and conditions, establishes a divided interest by and between multiple subscription beneficiaries with respect to a right to access the survival supplies);

non-ownership based rights of access (as may occur when the subscription, by its terms and conditions, establishes the aforementioned right of access via, for example, a lease, a rental, or borrowing construct);

option-based rights of access (as may occur when the subscription, by its terms and conditions, establishes a right for an authorized beneficiary to later obtain access to such resources upon, for example, paying an additional supplemental amount at that time).

If desired, a plurality of differentiated subscription opportunities can be offered in this regard. This plurality of differentiated subscription opportunities can correspond, for example, to providing access to differing selections and/or quantities of survival supplies. As but one very simple illustration in this regard, such subscription opportunities can differ from one another at least with respect to cost. This, in turn, provides subscriber choice with respect to selecting a particular subscription that best meets their specific needs and/or budget limitation.

These teachings also readily encompass the notion of a given subscriber providing such a subscription for an authorized beneficiary other than themselves. Such might occur, for example, when one family member procures such a subscription for one or more other family members. Another example would be for a company to subscribe on behalf of named key employees, family members of such key employees, and so forth. Other examples no doubt exist.

As noted, these subscriptions relate to providing access to survival supplies in the event of a civilly-catastrophic event. Such access may be predicated, if desired, upon a requirement that the civilly-catastrophic event be one that persists in substantial form for more than a predetermined period of time (such as one hour, one day, one week, and so forth) or that causes at least a predetermined amount or degree of infrastructure impairment or other measurable impact of choice. In addition, or in lieu thereof, such access may be predicated, if desired, upon a requirement of a particular level of objectivity or subjectively ascertained likelihood that a particular category or kind of civilly-catastrophic event will occur within a particular period of time.

As used herein, “civilly-catastrophic event” will be understood to refer to an event that substantially and materially disrupts a society's local, regional, and/or national infrastructure and ability to provide in ordinary course for at least one life-sustaining resource. Such a civilly-catastrophic event can include both a precipitating event (which may occur over a relatively compressed period of time or which may draw out over an extended period of time) as well as the resultant aftermath of consequences wherein the precipitating event and/or the resultant aftermath include both the cause of the infrastructure interruption as well as the continuation (or worsening) of that interruption.

A civilly-catastrophic event can be occasioned by any of a wide variety of natural and/or non-naturally-caused disasters. Examples of natural disasters that are potentially capable of initiating a civilly-catastrophic event include, but are not limited to, extreme weather-related events (such as hurricanes, tsunamis, extreme droughts, widespread or unfortunately-targeted tornadoes, extreme hail or rain, and the like, flooding, and so forth), extreme geological events (such as earthquakes, volcanic activity, and so forth), extreme space-based events (such as collisions with comets, large asteroids, and so forth, extreme solar flares, and the like), extreme environmental events (such as widespread uncontrolled fire or the like), and global or regional pandemics, to note but a few.

Examples of non-naturally-caused disasters capable of initiating a civilly-catastrophic event include both unintended events as well as intentional acts of aggression such as war, terrorism, madness, or the like. Examples of non-naturally-caused disasters capable of such potential scale include, but are not limited to, nuclear-related events (including uncontrolled fission or fusion releases, radiation exposure, and so forth), acts of war, the release of deadly or otherwise disruptive biological or chemical agents or creations, and so forth.

This process 100 also provides for acquiring or procuring 103 the corresponding survival supplies for the authorized beneficiaries. Such procurement can be achieved through any of a variety of means. By one approach the items may be acquired on the open market. By another approach the items may be purchased or otherwise acquired from third parties via private negotiations. By yet another approach the entity that provides and accepts these subscriptions may itself create (through manufacturing, farming, or the like) the items of interest. In some cases, the acquired item may comprise a staple of ordinary commerce. In other cases, the acquired item may be unique and/or proprietary to the acquiring/storing entity.

This process 100 then provides for creating 105 discrete sub-units of survival supplies. Each discrete sub-unit may be dedicated to like supplies. This can comprise, for example, creating a plurality of discrete sub-units dedicated to particular discrete categories of like survival supplies. By one approach, segregating the survival supplies is accomplished by segregating or removing the resources for one authorized beneficiary from a larger collective supply of resources. Further, such segregation of supplies may comprise encapsulating, bundling, or otherwise restraining the removed supplies. By another approach, the segregating the survival supplies can be accomplished by combining resources from several different sources. The sub-units may be a useful tool when delivering the survival supplies to the authorized beneficiaries, in response to a civilly-catastrophic event.

As mentioned, the discrete categories that correspond to the discrete sub-units are dedicated to a particular category of like resources. The discrete categories of sub-units might include, but are not limited to:

a nutritional and hydration supplies category (which may include fresh foods, dehydrated goods, nitrogen-packed foods, canned foods, freeze-dried foods, frozen foods, refrigerated foods, raw foods, processed foods, preserved foods, potable water, bottled water, vitamin supplements, water purification apparatus, water purification chemicals, sports drinks, energy drinks, and so forth):
a shelter supplies category (which may include lumber, nails, shingles, concrete, tools, tarps, tents, and so forth);
a sundries category (which may include personal hygiene items, toiletries for different ages and genders, batteries, flash lights, matches, lighters, thread, needles, and other sewing supplies, facial and body care products and so forth);
a tools category (which may include hunting and gathering tools, repair and maintenance tools, such as a hammer, nails, screw driver, screws, saw, tape measure, glue, tape, level, and so forth);
a medical and pharmaceutical supplies category (which may include first aid supplies, healthcare supplies, life support supplies, medicines, vaccines, specific illness related supplies, specific disease related supplies, long term care supplies, consumable medical supplies, non-consumable medical supplies, treatment equipment, stabilization equipment, long-term care equipment, diagnostic equipment, and so forth);
a clothing category (which may include adult, adolescent, child, infant, male, female, transgender, unisex or general clothing, suitable for various climate conditions, weather conditions, locations, likely threats, seasons, and so forth);
a communication category (which may include one-way communication facilities, two-way personal communication facilities, a wireless communication device, walkie-talkies, and so forth);
an entertainment category (which may include media supplies, games, games, reading material, sports equipment, and so forth);
a camping category (which may include a tent, a tarp, tools, lighting, power generation equipment, communication equipment, entertainment supplies, transportation vehicles, fire starting supplies, navigation equipment and aids, survival instructions, weapons, pack, load bearing equipment, and so forth);
a nutritional supplements and food preparation supplies category (which may include vitamin and mineral supplements, cookware, bakeware, a heat source, such as a stove, oven, gas-filled or charcoal grill, fire starting aids, a can opener, eating utensils, cutlery, dinnerware, glassware and so forth);
a lighting category (which may include power generation equipment, lights, lamps, lanterns, fuels, flash lights, fire starter, and so forth);
a power generation category (which may include electrical energy sources such as alternating current power sources, direct current power sources, fuel-consumptive power sources, renewable fuel source power sources, solar cells, generators, and so forth);
a transportation apparatus and supplies category (which may include a terrestrial vehicle, a water-borne vehicle, an air-borne vehicle, a hovercraft, and so forth);
a self-defense supplies category (which may include breathable air supplies, gas masks, filtered masks, particle masks, smoke hoods, face masks, head gear such as protective hats or helmets, firearms, ammunition, armor, debilitating sprays, other weapons such as projectile-based weaponry, blunt or sharp instruments, electromagnetic pulse protection or recovery supplies, and so forth);
a nuclear, biological, and chemical threat-abatement supplies category (which may include a gas mask, a filtered mask, breathable air supplies, sanitation supplies, radiation exposure related supplies, such as a radiation resistant suit, potassium iodide, wearable dosimeter, and so forth, chemical exposure related supplies, biological threat exposure related supplies, signal device, body armor, limb protection supplies, tools, bio-hazard suit, radiation suit, helmet, visor, ear protection, eye protection, and so forth);
a twenty-four hour supply kit category (which may include supplies sufficient for surviving a given consecutive twenty-four hour period of time such as: a basic communication device, such as a prepaid cellular telephone, walkie talkies, a signal mirror, and so forth; nutritional supplies such as food, vitamins and other dietary supplements; shelter supplies, such as a tent, sanitary facilities and supplies, tarps, and so forth; entertainment supplies, such as games, reading materials, audio and video platforms, and content; sundries, and so forth);
a seventy-two hour supply kit category (which may include supplies sufficient for surviving a given consecutive seventy-two hour period of time: a basic communication device, such as a prepaid cellular telephone, walkie talkies, a signal mirror, and so forth; nutritional supplies such as food, vitamins and other dietary supplements; shelter and camping supplies, such as a tent, sanitary facilities and supplies, tarps, and so forth; entertainment supplies, such as games, reading materials, audio and video platforms, and content; sundries, such as personal hygiene items, laundry products, and so forth);
a seven day supply kit category (which may include supplies sufficient for surviving a given consecutive seven-day period of time: a communication device, such as a prepaid cellular telephone, walkie talkies, a signal mirror, antenna tower, cellular telephone signal amplifier, and so forth; nutritional supplies such as food, vitamins and other dietary supplements; shelter and camping supplies, such as a tent, sanitary facilities and supplies, tarps, food preparation tools, cutting tools, inflatable and/or folding furniture, bedding supplies, such as sleeping bags, and so forth; entertainment supplies, such as games, reading materials, audio and video platforms, and content;
sundries; tools; lighting supplies; clothing supplies; medical supplies, such as first aid supplies, diagnostic equipment, medicines of various kinds; transportation supplies such as a collapsible bike, inflatable boat, and so forth; power generation supplies, such as batteries, generators, solar cells and so forth; threat abatements and self-defense supplies, and so forth);
a ten day supply kit category (which may include supplies sufficient for surviving a given consecutive ten-day period of time such as: a communication device, such as a prepaid cellular telephone, walkie talkies, a signal mirror, an antenna tower, a cellular telephone signal amplifier, and so forth; nutritional supplies such as food, vitamins and other dietary supplements; shelter and camping supplies, such as a tent, sanitary facilities and supplies, tarps, food preparation tools, cutting tools, inflatable and/or folding furniture, bedding supplies, such as sleeping bags, and so forth; entertainment supplies, such as games, reading materials, audio and video platforms, and content;
sundries; tools; lighting supplies; clothing supplies; medical supplies, such as first aid supplies, diagnostic equipment, medicines of various kinds; transportation supplies such as a collapsible bike, inflatable boat, and so forth; power generation supplies, such as batteries, generators, solar cells and so forth; threat abatements and self-defense supplies, and so forth);
a fourteen day supply kit category (which may include supplies sufficient for surviving a given consecutive fourteen-day period of time such as: a communication device, such as a prepaid cellular telephone, walkie talkies, a signal mirror, an antenna tower, a cellular telephone signal amplifier, and so forth; nutritional supplies such as food, vitamins and other dietary supplements; shelter and camping supplies, such as a tent, sanitary facilities and supplies, tarps, food preparation tools, cutting tools, inflatable and/or folding furniture, bedding supplies, such as sleeping bags, and so forth; entertainment supplies, such as games, reading materials, audio and video platforms, and content; sundries; tools; lighting supplies; clothing supplies; medical supplies, such as first aid supplies, diagnostic equipment, medicines of various kinds; transportation supplies such as a collapsible bike, inflatable boat, and so forth; power generation supplies, such as batteries, generators, solar cells and so forth; threat abatements and self-defense supplies, and so forth);
a thirty day supply kit category (which may include supplies sufficient for surviving a given consecutive thirty-day period of time such as: a communication device, such as a prepaid cellular telephone, walkie talkies, a signal mirror, an antenna tower, a cellular telephone signal amplifier, and so forth; nutritional supplies such as food, vitamins and other dietary supplements; shelter and camping supplies, such as a tent, sanitary facilities and supplies, tarps, food preparation tools, cutting tools, inflatable and/or folding furniture, bedding supplies, such as sleeping bags, and so forth; entertainment supplies, such as games, reading materials, audio and video platforms, and content; sundries; tools; lighting supplies; clothing supplies; medical supplies, such as first aid supplies, diagnostic equipment, medicines of various kinds; transportation supplies such as a collapsible bike, inflatable boat, and so forth; power generation supplies, such as batteries, generators, solar cells and so forth; threat abatements and self-defense supplies, and so forth);
   to note a few. By one approach, all of the food, potable water, and other nutritional and hydration supplies can be segregated and grouped together as a shared or common sub-unit. The short term kits detailed above include supplies for one, three, seven, ten, fourteen, and thirty days, however, an authorized beneficiary may request a number of short term supply kits suitable for varying periods of time. For example, a beneficiary may request a one day supply kit and a one hundred day supply kit.

In addition, the sub-units may be further compartmentalized. For example, the nutrition and hydration sub-unit may be separately grouped such that within the nutritional and hydration category, there are separate sub-categories for hydration and nutrition. Such further compartmentalization may encourage or facilitate proper stocking and rotation of inventory, packing, packaging, storage, pre-positioning, and delivery. Like the sub-units themselves, the compartments of a sub-unit may be stored separately. For example, within the nutritional and hydration supplies sub-unit, the nutrition compartment may need to be frozen whereas the hydration compartment may require room-temperature storage. The sub-units may be compartmentalized based upon a number of factors, such as, for example, when the resources must be rotated or otherwise updated to ensure quality. Such rotational maintenance may be expedited due to the structure of the unit through sub-unit and compartmentalization as discussed below.

In one form, creating 105 the sub-units may include segregating the supplies, such as by partitioning off the supplies of one authorized beneficiary from a larger aggregation of supplies. For example, segregating can include removing a carton or small box of supplies from a larger bin or larger pallet of aggregated supplies. In another form, the segregation can occur by gathering different supplies, possibly procured from different sources, into a sub-unit. Segregating supplies occurs, for example, when a flashlight, a tent, a lantern, fire starter, walkie-talkies, and matches are acquired and then are combined to create the camping supplies sub-unit. In yet another form, creating 105 the sub-unit may comprise both partitioning off a portion of supplies and combining supplies from different sources.

By creating 105 sub-units of survival supplies, the supplies are provided with an increased level of organization. Upon receipt of the supplies, the authorized beneficiary can quickly find items without having to organize or inventory the items received. The sub-unit organization makes the supplies easier to locate and access when they are needed by the authorized beneficiary. Upon occurrence of a civilly-catastrophic event, many individuals may experience some confusion, anxiety, and fear among other emotions. It is during these emotionally charged moments that authorized beneficiaries will likely need access to a number of the supplies. Therefore, storing the supplies in a coordinated and systematic manner can increase the likelihood that an authorized beneficiary will be able to find particular supplies when needed most.

Creating 105 sub-units can provide segregation between supplies that have a high potential for reactivity, flammability, and contamination from other supplies. In addition, certain storage requirements regarding such factors as air pressure, air quality, humidity, temperature, light sensitivity, and moisture levels can be more easily accommodated by having separately stored supplies.

To assist the authorized beneficiary in finding particular supplies, a supply list providing the authorized beneficiary with sub-unit and compartment information can accompany the resources. The sub-units may be stored or packaged in a manner to distinguish sub-units from one another and such identifying characteristics may be included in the supply list. For example, the sub-units or the sub-unit packaging may be color coded or affixed with printed graphics, symbols, or other indicia. In another embodiment, any item requiring prompt access can be provided with an alarm or tracking device that can indicate the item's location. It is also contemplated that particular sub-units themselves can be provided with indicators, alarms, or tracking devices for quick location. In yet another form, the sub-units are stored in transparent packaging, for example clear plastic containers, such that the supplies stored therein can be seen and identified without opening the sub-unit. In another form, the authorized beneficiary may receive a map or diagram such that particular sub-units can be more easily located. Such a map would provide the location of a particular sub-unit relative to the other sub-units of the unit.

In addition, storing supplies in sub-units allows the storage containers to be customized to the supplies stored therein. Depending on the category of supplies, the container or packaging may need to be: double walled, reinforced, heat resistant, non-conductive, insulated, lightweight, durable, corrosion resistant, or refrigerated to name a few. For example, while certain nourishment supplies may require storage in heat resistant packaging the clothing supplies do not require such accommodations and therefore may be stored more cost effectively in other packaging.

The sub-units may be stored separately at different locations or under different conditions, as discussed below. Storing the sub-units at separate locations minimizes the risk associated with the loss of resources. For example, supplies can be lost due to weather damage, natural disasters, looting, animal contamination, spoiling, and so forth. Sub-units may be stored in different geographic locations that may have varying climate or population conditions and may be exposed to different likely threats. In addition to reducing the risk of resource loss, some resources may be better preserved being stored at subterraneous locations. Thus, for supplies that can be stored for long periods of time, subterranean storage is possible since those supplies can be segregated from the perishable items that require more frequent access. When the authorized beneficiary may require access may affect where the supplies are stored. Since the sub-units may also be stored in varying distances from the authorized beneficiary, it may be helpful to store the short term supplies within relative proximity to the authorized beneficiary.

This process 100 also provides for forming 107 the sub-units into a unit of survival supplies. As shown in FIG. 2, such a unit 201 is comprised of a number of smaller sub-units 203. This can comprise assembling together all of the sub-units for one authorized beneficiary or assembling together portions or a few, but not all, of the sub-units for one authorized beneficiary. Assembling the entire unit is beneficial for quick dispatch of the supplies. However, assembling only a portion of the total sub-units allows for separate storage of the sub-units. This can comprise having a partially disassembled unit or sub-unit to accommodate different storage locations or different storage conditions, such as air quality, and temperature. For example, some supplies may be suitable for storage at room temperature, while other supplies may require or benefit from frozen storage. By way of another example, an authorized beneficiary may need convenient access to a short term supply sub-unit (such as a twenty-four hour, seventy-two hour, seven day, ten day, fourteen day, or thirty day short term supply sub-unit) and therefore, those sub-units may be stored at the authorized beneficiary's home or at a storage facility relatively proximal to the authorized beneficiary's home or principal location. The usefulness of the supplies can be affected by how quickly the authorized beneficiary can receive her supplies and therefore proximity of the supplies can be of significant importance. It may be beneficiary to store certain sub-units at different locations relatively distal from one another. Some supplies may not be able to be stored together due to a risk of reactivity, or potential for contamination. Certain supplies will likely require more frequent access than others and storing a number of these supplies together can prevent the maintenance staff from disassembling the entire unit to change or rotate a few supplies. For example, if the medical and pharmaceutical supplies are frequently updated to track an authorized beneficiary's changing medical condition, then access to that sub-unit may be required more frequently than other sub-units. Thus, forming 107 the sub-units can encompass all or most of the sub-units or just a few of the sub-units with other sub-units to be added at a later point in time.

In one form, forming 107 the unit of sub-units can comprise assembling together the discrete sub-units. This assembly may depend on the method of storing the supplies in the sub-unit. For example, the supplies of the sub-unit may be stored in plastic inter-locking containers and thus, forming the unit entails locking at least two of the individual sub-units together. In another form, the supplies of the sub-unit are stored in at least one cardboard box and the assembly of the unit may comprise positioning the boxes upon a pallet and fastening them to the pallet and to each other. The sub-units may also be coded, such as by color or graphics, such that assembling the unit requires the inclusion of each of a plurality of particularly coded sub-units.

Forming 107 the unit can employ the use of containers, pallets, tie-downs, tarps, rope, twine, cabinets, boxes, shrink wrap, interlocking containers, partially or fully nesting containers, snaps, zippers, hooks and loop fasteners, magnets, adhesives, tape, gravity, and/or centrifugal force, electricity, to note but a few.

In one embodiment, a basic or standard sub-unit is available within each supply category. The standard sub-units can be formed together to form a universal unit. This universal unit preferably includes the staple items that an authorized beneficiary will require to sustain themselves for a certain period of time. The universal unit is preferably a largely unisex, uni-age, one-size-fits-all selection of supplies. Utilizing universal units allows for some convenience with respect to managing the resources. The unit enjoys a certain level of fungibility such that the unit received by one authorized beneficiary is nearly identical to that received by another. As described below, the sub-units may be differentiated and a sub-unit in a particular category can be exchanged for another sub-unit in that category. If the authorized beneficiary elects to differentiate a particular sub-unit, the function of the sub-unit remains the same and the unit retains a level of functional fungibility. In yet another form, the universal unit comprised of standard sub-units can be supplemented by add-ons, such that an authorized beneficiary can request additions while retaining the standard sub-unit supplies. By one approach, a number of additional sub-units will include the additional resources requested by the authorized beneficiary and then those additional sub-units can be added to the pallet of standard sub-units. By having a universal unit with added features, the authorized beneficiary has a partially customized unit without having to pay for an entirely customized selection.

Standardization of at least a portion of the supplies may also increase the ability to quickly deliver supplies to an authorized beneficiary that has traveled away from her home or principal location. If a civilly-catastrophic event occurs when the authorized beneficiary is relatively distal from the beneficiary's unit, the standard or universal sub-units may be supplied from a stock of resources more proximal to the beneficiary. Further, if the authorized beneficiary has added a few additional customized sub-units only those sub-units will need to be shipped to the location of the authorized beneficiary. Thus, having a standard or universal unit with a few additional customized sub-units may provide the authorized beneficiary with a level of increased mobility.

In another form, the differentiated sub-units can be combined in various combinations to create a unit that is more personal to the authorized beneficiary receiving the unit than the universal unit. In one form, only a few of the differentiated sub-units will be exchanged for standard sub-units such that the unit is comprised of both standard and differentiated sub-units. In another form, the unit will comprise entirely of differentiated sub-units such that each the personal unit has a high level of customization. Thus, the personal unit provides the authorized beneficiary, who has upgraded particular categories of supplies to one of the differentiated sub-units, a partially customized unit without having to pay for an entirely customized selection of supplies.

The process 100 also provides for differentiating 109 the sub-units of survival supplies within a category of supplies. The differentiated sub-units correspond to the same particular discrete category of survival supplies, but contain different kinds or types of survival supplies within one category of supplies. The difference in supplies can be quite small or can become quite significant. For example, within the clothing sub-unit category, differentiated sub-units may be available that contain adult female or adult male clothing. Further, the standard sub-unit included in the universal unit may contain unisex clothing that can be used for a broad range of ages and sizes. By way of another example, the tools category may be differentiated by the number of separate tools included in the sub-unit: one sub-unit may include a number of handheld power tools while another sub-unit may include a single table-top or bench tool that can accomplish the same tasks.

Providing for differentiation of the sub-units allows the unit to be tailored to the preferences, requirements, and needs of the authorized beneficiary in addition to the conditions and requirements of potential civil-catastrophes. Differentiated sub-units also provide a level of customization without having to construct an entire unit by deciding on each detail and starting from scratch. In one form, the differentiated sub-units are predetermined such that the authorized beneficiary has a number of choices within each supply category. Differentiation of sub-units creates a semi-customized unit because an authorized beneficiary can choose her sub-units from a selection of available differentiated sub-units.

In one embodiment, the differentiated sub-units are functionally fungible with respect to one another. The sub-units in such cases can be exchanged for one another. Having sub-units with a level of interchangeability allows the sub-units to be more easily substituted for one another when formed into a unit. Increased fungibility can be particularly beneficial with respect to effecting the proper stocking and rotation of inventory, packing, packaging, storage, pre-positioning, and delivery of such survival supplies.

In one preferred embodiment, it is expected that each category of sub-unit will have at least one differentiated sub-unit. These sub-units can be differentiated based on a number of factors that might include, but are not limited to:

age of the authorized beneficiary;

experience of the authorized beneficiary (such as whether the authorized beneficiary will have the skill level to employ the use of certain supplies, and so forth);

interests of the authorized beneficiary;

gender of the authorized beneficiary;

location (such as the principal location of the authorized beneficiary, the storage location of a plurality of the survival supplies and the most likely threat at the principal location or the authorized beneficiary, and so forth);

likelihood of use (such as whether the authorized beneficiary will be able to use the supplies and the probability of whether the need to use supplies will materialize, and so forth);

cost;

brand;

packaging;

size;

portability (such as the size and weight considerations, whether the supplies include wheels, runners, handles, and so forth);

durability;

accessibility;

availability (such as whether the supplies are easy or difficult to procure, and so forth);

ease of use;

training requirements;

season and seasonal requirements;

color;

smell;

noise;

taste;

touch;

compatibility;

interoperability;

threat assessment;

additional supplies provided;

medical conditions (including whether an authorized beneficiary suffers from a particular medical condition that requires treatment or whether an individual's general medical condition requires preventative measures to avoid developing certain medical problems, and so forth); and/or

information included;

shape;

composition;

efficacy;

personal preference;

type of material;

number of individuals that can utilize the supplies;

number of individuals accommodated;

weather requirements;

power production capacity;

fuel requirements;

weight;

the degree to which the supplies can be concealed;

fire power;

caliber;

rate of fire;

threat mitigation;

viability;

length of protection;

functionality;

nutritional value;

to note but a few examples. By one approach, for example, differentiation based on gender may comprise having male specific clothing in one clothing sub-unit and female-specific clothing in another clothing sub-unit. Along these same lines, it would also be possible for the sub-units to comprise supplies that are at least primarily directed to a particular age range. Similarly, it is also contemplated that the sub-units will be directed to different sizes of beneficiary. For example, the clothing may be provided in sizes ranging from petite dimensions to very large dimensions.

The process 100 also optionally provides for maintaining 111 the discrete sub-units of survival supplies pending a need to permit subscription-based access to the supplies. The specifics of such maintenance will of course vary with respect to the nature of the resource or resources being maintained and also preferences of the authorized beneficiary and/or subscriber. As suggested above, the supplies may be stored in unit form or in a partial unit. Grouping or segregating the supplies into sub-units may significantly impact the maintenance process. Maintaining the supplies may comprise ensuring the utility of the stored supplies. The supplies may need to be updated on a periodic basis to ensure, for example, freshness, usability, and efficacy of the supplies. In one form, this can comprise monitoring the usability of perishable items and replacing such items on a corresponding schedule. As another simple illustration this step can comprise holding certain items in deep refrigeration or in other special storage conditions as may suit the proper maintenance of such items.

Such maintenance can also optionally comprise making adjustments to such supplies to reflect dynamically changing circumstances as occur during the consideration-based private civil security subscription period. Advancements in technology will often produce more efficient and effective resources, such that the previously stored resources will need to be substituted. As one illustration, a new item may become available that is particularly useful in dealing with or otherwise surmounting some condition that may likely arise upon the occurrence of a particular kind of civilly-catastrophic event. In such a case, maintaining such supplies can readily accommodate updating the acquired and stored items to include a supply of this new item.

Accordingly, such maintenance can readily comprise one or more of removing a particular one of the items (as when a better substitute becomes available, when the item itself is shown to be less effective for its intended purpose than was originally thought, when the authorized beneficiary has chosen to receive another item, and so forth), adding additional ones of the stored supply (as when it becomes subsequently understood that more of a particular item is desired to achieve a particular survival related goal or purpose, or an authorized beneficiary has changed preference), adding at least one new supply that is not already stored (as in the example provided above) and so forth.

As suggested, maintenance of the survival supplies and resources is further by having sub-units, sub-units that are further compartmentalized and components. These divisions can facilitate better, more efficient and effective, organization, management, and selection of supplies. Supplies that require frequent maintenance and need to be more easily accessible can be stored in a more convenient location. If desired, the sub-units requiring such frequent access can be stored separate from other sub-units of the unit or can be stored in a relatively accessible portion of the unit. For example, if the medical and pharmaceutical sub-unit requires maintenance on a more frequent basis than the most of the other sub-units, the medical and pharmaceutical sub-unit can be stored separately from the other sub-units. Further, a plurality of the medical and pharmaceutical sub-units can be stored together such that when maintenance (such as removing, exchanging, or adding an item) must occur, all of the sub-units requiring such maintenance can be efficiently updated.

It will be appreciated that these teaching provide for a highly flexible yet powerfully effective way by which a modern citizen can greatly improve their likelihood of surviving a civilly-catastrophic event. These teachings are sufficiently flexible so as to accommodate the needs and desires of a wide-ranging set of potential beneficiaries while nevertheless still tending to ensure adequate access to the basic necessities of life. Further, the teachings provide a manner to accommodate the individual beneficiary while creating a viable manner to implement such a large-scale provision of survival supplies. Though training and some related activity may be provided and encouraged, in general the beneficiary receives those benefits without being required

Those skilled in the art will recognize that a wide variety of modifications, alterations, and combinations can be made with respect to the above described embodiments without departing from the spirit and scope of the invention, and that such modifications, alterations, and combinations are to be viewed as being within the ambit of the inventive concept.

I claim:

1. A method comprising:
accepting pre-catastrophe consideration-based private civil security subscriptions from subscribers with respect to providing civilly-catastrophic event-based access to survival supplies for authorized beneficiaries; and
creating discrete sub-units of survival supplies dedicated to corresponding particular discrete categories of survival supplies.

2. The method of claim 1 further comprising forming units comprised of sub-units of survival supplies.

3. The method of claim 2 wherein the unit comprises sufficient survival supplies to sustain at least one authorized beneficiary for at least one year.

4. The method of claim 1 wherein creating discrete sub-units of survival supplies further comprises creating differentiated sub-units wherein the differentiated sub-units correspond to a same one of the particular discrete categories of survival supplies but are differentiated by inclusion of different kinds of survival supplies within that same one of the particular discrete categories, such that different kinds of a same category of survival supplies are available to authorized beneficiaries.

5. The method of claim 1 wherein the particular discrete categories comprise at least one of:
a nutritional and hydration supplies category;
a shelter supplies category;
a sundries category;
a tools category;
a medical and pharmaceutical supplies category;
a clothing category;
a communication category;
an entertainment category;
a camping category;
a nutritional supplements and food preparation supplies category;
a lighting category;
a power generation category;
a transportation apparatus and supplies category;
a self-defense supplies category;
a nuclear, biological, and chemical threat-abatement supplies category;
a twenty-four hour supply kit category;
a seventy-two hour supply kit category;
a seven day supply kit category;
a ten day supply kit category;
a fourteen day supply kit category;
a thirty day supply kit category.

6. The method of claim 5 wherein the discrete sub-units dedicated to the nutritional and hydration supplies category are differentiated based upon at least one of:
age;
gender;
location;
likelihood of use;
cost;
brand;
packaging;
size;
portability;
weight;
shelf life;
accessibility;
ease of use;
storage requirements;
appearance;
texture;
color;
odor;
taste;
mouth feel;
touch;
nutritional content;
sound;
compatibility;
climate;
shape;
composition;
efficacy;
personal preference.

7. The method of claim 5 wherein the discrete sub-units dedicated to the shelter supplies category are differentiated based upon at least one of:
location (include geographical, and subterranean locations);
age and experience levels;
threat assessment;
likelihood of use;
cost;
brand;
packaging;
size;
ruggedness;
water resistance;
tear resistance;
puncture resistance;
portability;
weight;
accessibility;
texture;
ease of use;
color;
smell;
noise;
touch;
compatibility;
climate;
shape;
composition;
efficacy;
personal preference.

8. The method of claim 5 wherein the discrete sub-units dedicated to the sundries category are differentiated based upon at least one of:
age;
gender;
location;
likelihood of use;
cost;
brand;
packaging;
size;
texture;
portability;
accessibility;
ease of use;
color;
smell;
noise;
taste;
touch;
compatibility;
interoperability.

9. The method of claim 5 wherein the discrete sub-units dedicated to the tools category are differentiated based upon at least one of:
age and experience levels;
additional supplies provided;
location;
likelihood of use;
cost;
brand;
packaging;
ruggedness;
size;
texture;
portability;
accessibility;
ease of use;
color;
smell;
noise;
compatibility;
interoperability;
shape;
composition;
efficacy;
personal preference.

10. The method of claim 5 wherein the discrete sub-units dedicated to the medical and pharmaceutical supplies category are differentiated based upon at least one of:
medical conditions;
location;
age;
gender;
likelihood of use;
threat assessment;
cost;
brand;
genericness;
packaging;
texture;
size;
portability;
shelf life;
accessibility;
ease of use;
color;
smell;
noise;
taste;
touch;
compatibility;
interoperability.

11. The method of claim 5 wherein the discrete sub-units dedicated to the clothing category are differentiated based upon at least one of:
gender;
age;
season;
location;
cost;
brand;
packaging;
size;
texture;
portability;
accessibility;
ease of use;
color;
smell;
touch;
compatibility;
interoperability;
shape;
composition;
efficacy;
personal preference;
types of material.

12. The method of claim 5 wherein the discrete sub-units dedicated to the communication category are differentiated based upon at least one of:
threat assessment;
location;
likelihood of use;
age and experience levels;
cost;
brand;
packaging;
portability;
range;
power supply;
multiple-systems compatibility;
encryption;
supported communication modes;
accessibility;
texture;
ease of use;
color;
noise;
touch;
compatibility;
interoperability;
range of operation;
method of operation;
frequency of operation.

13. The method of claim 5 wherein the discrete sub-units dedicated to the entertainment category are differentiated based upon at least one of:
age and experience levels;
interests;
gender;
location;
cost;
brand;
packaging;
size;
portability;
accessibility;
texture;
ease of use;
color;
smell;
noise;
taste;
touch;
compatibility;
interoperability;
number of individuals that can utilize the supplies;
number of entertainment options.

14. The method of claim 5 wherein the discrete sub-units directed to the camping category are differentiated based upon at least one of:
threat assessment;
location;
likelihood of use;
age and experience levels;
cost;
brand;
packaging;
size;
portability;
accessibility;
texture;
ease of use;
color;
smell;
noise;
taste;
touch;
compatibility;
interoperability;
seasonal requirements;
weather requirements;
number of persons accommodated.

15. The method of claim 5 wherein the discrete sub-units directed to the nutritional supplements and preparation supplies category are differentiated based upon at least one of:
location;
likelihood of use;
age;
gender;
cost;
brand;
packaging;
shelf life;
size;
portability;
accessibility;
texture;
ease of use;
color;
smell;
noise;
taste;
touch;
compatibility;
interoperability;
shape;
composition;
efficacy;
personal preference.

16. The method of claim 5 wherein the discrete sub-units directed to the lighting category are differentiated based upon at least one of:
threat assessment;
location;
likelihood of use;
age and experience levels;
cost
brand;
packaging;
size;
portability;
durability;
power consumption;
output lumens;
accessibility;
ease of use;
color;
smell;
noise;
touch;
compatibility;
interoperability;
shape;
composition;
efficacy;
personal preference.

17. The method of claim 5 wherein the discrete sub-units directed to the power generation category are differentiated based upon at least one of:
threat assessment;
location;
likelihood of use;
age and experience levels;
cost;
brand;
packaging;
size;
portability;
accessibility;
ease of use;
smell;
noise;
touch;
compatibility;
interoperability;
shape;
composition;
efficacy;
personal preference;
power production;
fuel requirements;
weight.

18. The method of claim 5 wherein the discrete sub-units directed to the transportation apparatus and supplies category are differentiated based upon at least one of:
threat assessment;
location;
likelihood of use;
age and experience levels;
cost;
brand;
packaging;
size;
portability;
durability;
accessibility;
ease of use;
color;
smell;
noise;
compatibility;
interoperability.

19. The method of claim 5 wherein the discrete sub-units directed to the self-defense supplies category are differentiated based upon at least one of:
threat assessment;
location;
likelihood of use;
age and experience levels;
cost;
brand;
packaging;
size;
portability;
training requirements;
accessibility;
ease of use;
color;
noise;
touch;
compatibility;
interoperability;
shape;
composition;
efficacy;
personal preference;
range;
the degree to which the supplies can be concealed;
fire power;
caliber;
rate of fire.

20. The method of claim 5 wherein the discrete sub-units directed to the nuclear, biological, and chemical threat-abatement supplies category are differentiated based upon at least one of:
availability;
threat assessment;
location;
likelihood of use;
age and experience levels;
cost;
brand;
packaging;
size;
portability;
multi-threat abatement capability;
shelf life;
durability;
effectiveness;
accessibility;
ease of use;
smell;
noise;
taste;
touch;
compatibility;
interoperability;
shape;
composition;
efficacy;
personal preference;
threat mitigation;
efficacy;
viability;
length of protection;
functionality.

21. The method of claim 5 wherein the discrete sub-units directed to the twenty-four hour supply kit category are differentiated based upon at least one of:
gender;
medical conditions;
threat assessment;
location;
likelihood of use;
age and experience levels;
information included within the kit;
cost;
comprehensiveness;
shelf life;
brand;
packaging;
size;
portability;
accessibility;
texture;
ease of use;
color;
smell;
noise;
taste;
touch;
shape;
composition;
efficacy;
personal preference;
nutritional value.

22. The method of claim 5 wherein the discrete sub-units directed to the seventy-two hour supply kit category are differentiated based upon at least one of:
gender;
medical conditions;
threat assessment;
location;
likelihood of use;
age and experience levels;
information included within the kit;
cost;
brand;
packaging;
comprehensiveness;
shelf life;
size;
portability;
accessibility;
texture;
ease of use;
color;
smell;
noise;
taste;
touch;
shape;
composition;
efficacy;
personal preference;
nutritional value.

23. The method of claim 5 wherein the discrete sub-units directed to the seven day supply kit category are differentiated based upon at least one of:
gender;
medical conditions;
threat assessment;
location;
likelihood of use;
age and experience levels;
information included within the kit;
cost;
brand;
packaging;
comprehensiveness;
shelf life;
size;
portability;
accessibility;
texture;
ease of use;
color;
smell;
noise;
taste;
touch;
shape;
composition;
efficacy;
personal preference;
nutritional value.

24. The method of claim 5 wherein the discrete sub-units directed to the ten day supply kit category are differentiated based upon at least one of:
gender;
medical conditions;
threat assessment;
location;
likelihood of use;
age and experience levels;
information included within the kit;
cost;
brand;
packaging;
comprehensiveness;
shelf life;
size;
portability;
accessibility;
texture;
ease of use;
color;
smell;
noise;
taste;
touch;
shape;
composition;
efficacy;
personal preference;
nutritional value.

25. The method of claim 5 wherein the discrete sub-units directed to the fourteen day supply kit category are differentiated based upon at least one of:
gender;
medical conditions;
threat assessment;
location;
likelihood of use;
age and experience levels;
information included within the kit;
cost;
brand;
packaging;
comprehensiveness;
shelf life;
size;
portability;
accessibility;
texture;
ease of use;
color;
smell;
noise;
taste;
touch;
shape;
composition;
efficacy;
personal preference;
nutritional value.

26. The method of claim 5 wherein the discrete sub-units directed to the thirty day supply kit category are differentiated based upon at least one of:
gender;
medical conditions;
threat assessment;
location;
likelihood of use;
age and experience levels;
information included within the kit;
cost;
brand;
packaging;
comprehensiveness;
shelf life;
size;
portability;
accessibility;
texture;
ease of use;
color;
smell;
noise;
taste;
touch;
shape;
composition;
efficacy;
personal preference;
nutritional value.

27. The method of claim 5 wherein a plurality of standard discrete sub-units are combined to form a universal unit.

28. The method of claim 5 wherein a plurality of standard discrete sub-units are combined to form a universal unit and the universal unit is supplemented according to requests of the authorized beneficiary.

29. The method of claim 5 wherein discrete differentiated sub-units are combined to create a personal unit.

30. The method of claim 29 wherein the discrete differentiated sub-units are combined in a plurality of different combinations.

31. The method of claim 5 wherein at least one standard discrete sub-unit and at least one differentiated sub-unit are combined to form a personal unit.

32. The method of claim 31 wherein the at least one standard discrete sub-unit and at least one differentiated sub-unit are combined in a plurality of different combinations.

33. The method of claim 5 wherein the discrete sub-units are segregated during storage based upon a frequency of required maintenance, where the sub-units that are comprised of supplies with a longer shelf-life are combined during storage and the sub-units that are comprised of supplies requiring relatively frequent maintenance are stored separately.

34. The method of claim 5 wherein the discrete sub-units are compartmentalized into compartments such that the supplies are segregated amongst the compartments based, at least in part, upon a frequency of corresponding planned maintenance.

35. The method of claim 34 wherein the compartments of the sub-units are at least one of:
disposed relatively proximal to one another;
disposed relatively distal to one another.

36. The method of claim 1 further comprising creating a unit with discrete sub-units wherein the discrete sub-units that share a particular discrete category are functionally fungible substitutes for one another notwithstanding differences in kind between one another.

37. The method of claim 1 further comprising creating at least one customizable discrete sub-unit to store particular items chosen by the authorized beneficiary.

38. The method of claim 1 wherein the sub-units may be physically aggregated using at least one of:
a container;
a pallet;
a tie-down;
a tarp;
rope;
twine;
a cabinet;
a box;
shrink wrap;
interlocking containers;
at least partially nesting containers;
snaps;
zippers;
hooks and loops-based fasteners;
magnets;
adhesives;
tape;
gravity;
centrifugal force;
electricity.

39. The method of claim 1 wherein the discrete sub-units of survival supplies comprises a short term sub-unit directed to survival for at least one hour.

40. The method of claim 39 wherein the short term sub-unit may be comprised of:
a one hour supply kit;
a twenty-four hour supply kit;
a forty-eight hour supply kit;
a seventy-two hour supply kit;
a seven day supply kit;
a ten day supply kit;
a fourteen day supply kit;
a thirty day supply kit;
a forty-five day supply kit;
a ninety day supply kit;
a one hundred day supply kit.

41. A method comprising:
accepting pre-catastrophe consideration-based private civil security subscriptions from subscribers with respect to providing civilly-catastrophic event-based access to survival resources;
organizing the survival resources into components of like resources.

42. The method of claim 41 further comprising differentiating at least some of the components of like resources from one another with respect to their contents.

43. The method of claim 42 wherein each of the differentiated components comprise one of:
medical supplies;
clothing supplies;
toiletries;
nutrition and hydration supplies;
threat-abatement supplies;
evacuation, shelter, and camping supplies;
short term supplies;
entertainment supplies;
educational supplies;
life support supplies.

44. The method of claim 43 wherein the medical supplies component comprises at least one of:
first-aid supplies;
pharmacological supplies;
specific illness related supplies;
specific disease related supplies;
long term care supplies;
consumable medical supplies;
non-consumable medical supplies;
treatment equipment;
stabilization equipment;
long-term care equipment;
diagnostic equipment.

45. The method of claim 43 wherein the clothing component comprises one of:
adult female clothing supplies;
adult male clothing supplies;
adult transgender clothing supplies;
adolescent female clothing supplies;
adolescent male clothing supplies;
adolescent transgender clothing supplies;
child female clothing supplies;
child male clothing supplies;
infant female clothing supplies;
infant male clothing supplies;
general adult clothing;
general adolescent clothing;
general child clothing;
general infant clothing.

46. The method of claim 45 wherein the clothing components are differentiatable based upon at least one of:
weather;
location;
season;
threat assessment;
fashion;
utility;
weight.

47. The method of claim 43 wherein the toiletries component comprise one of:
adult male supplies;
adult female supplies;
adolescent male supplies;
adolescent female supplies;
child male supplies;
child female supplies;
infant supplies.

48. The method of claim 43 wherein the nutrition and hydration supplies component comprises at least one of:
fresh foods;
dehydrated foods;
nitrogen-packed foods;
canned foods;
freeze-dried foods;
frozen foods;
refrigerated foods;
raw foods;
processed foods;
preserved foods;
potable water;
bottled water;
vitamin supplements.

49. The method of claim 43 wherein the threat-abatement component comprises at least one of:
a gas mask;
a filtered mask;
a smoke hood;
self-defense weaponry;
breathable air supplies;
radiation exposure related supplies;
chemical exposure related supplies;
biological threat exposure related supplies;
signal device;
body armor;
limb protection supplies;
tools;
bio-hazard suit;
radiation suit;
helmet;
visor;
ear protection;
eye protection.

50. The method of claim 43 wherein the evacuation, shelter, and camping supplies component comprises at least one of:
a tent;
a tarp;
tools;
lighting;
power generation equipment;
communication equipment;
entertainment supplies;
transportation;
fire starting supplies;
a navigation aid;
survival instructions;
a weapon;
pack
load bearing equipment.

51. The method of claim 43 wherein the short term supplies component comprises one of:
a one hour supply kit;
a twenty-four hour supply kit;
a forty-eight hour supply kit;
a seventy-two hour supply kit;
a four day supply kit;
a five day supply kit;
a six day supply kit;
a seven day supply kit;
an eight day supply kit;
a nine day supply kit;
a ten day supply kit;
a fourteen day supply kit;
a thirty day supply kit.
